(19) United States
(12) Patent Application Publication
(10) Pub. No.: US 2004/0233961 A1
(43) Pub. Date: Nov. 25, 2004

(54) Optically pumped semiconductor device

(75) Inventor: Stephan Lutgen, Regensburg (DE)

Correspondence Address: LERNER AND GREENBERG, PA, P O BOX 2480, HOLLYWOOD, FL, 33022-2480, US

(73) Assignee: Osram Opto Semiconductor GmbH

(21) Appl. No.: 10/852,949

(22) Filed: May 24, 2004

(30) Foreign Application Priority Data
May 23, 2003 (DE) 103 23 821.2

(51) Int. Cl. H01S 3/091

(52) U.S. Cl. 372/70; 372/69

(57) ABSTRACT

An optically pumped semiconductor device has a semiconductor body containing a vertically emitting quantum well structure for generating a vertical radiation field. The quantum well structure contains a plurality of quantum layers between which barrier layers are disposed, and the quantum layers are provided for optically pumping by a pump radiation field. The semiconductor device has a vertical resonator for the pump radiation field with a mirror layer disposed on the semiconductor body, the quantum well structure is disposed in the resonator.

### BACKGROUND OF THE INVENTION

Field of the Invention

The present invention relates to an optically pumped semiconductor device having a semiconductor body containing a vertically emitting quantum well structure for generating a vertical radiation field. The quantum well structure has a plurality of quantum layers between which barrier layers are disposed. The quantum layers are provided for optically pumping by a pump radiation field.

A semiconductor device of the generic type is disclosed, for example, in the International Patent Disclosure Document WO 01/93386, corresponding to U.S. Patent Publication No. 20020001328 A1, which describes an optically pumped vertical emitter, which is embodied in a manner monolithically integrated together with a pump radiation source, for example an edge-emitting semiconductor laser. The vertical emitter contains a vertically emitting quantum well structure which is optically pumped by the pump radiation generated by the pump radiation source, so that the vertically emitting quantum well structure generates a vertically propagating radiation field. As an alternative to a monolithically integrated pump radiation source, the pump radiation may also be generated by an external pump radiation source. In this case, the pump radiation is generally radiated obliquely onto a surface of the semiconductor device.

In both cases, it is advantageous with regard to an efficient pump process to embody the pump radiation source and the vertical emitter such that the pump wavelength, e.g. the wavelength of the pump radiation field, is less than the emission wavelength, e.g. the wavelength of the radiation generated by the vertically emitting quantum well structure.

With regard to optical pumping, a distinction is made between two complementary pump mechanisms, a quantum well structure having a plurality of quantum layers with barrier layers disposed in between being taken as a basis in both cases.

In the case of the first pump mechanism, the wavelength of the pump radiation is chosen such that the pump radiation is absorbed in the barrier layers disposed between the quantum wells. The absorption of the pump radiation leads to the generation of electron-hole pairs which then occupy the lower-energy states of the quantum layers, thus resulting in a population inversion in the quantum layers. A vertical radiation field is generated by the population inversion.

In the case of the second pump mechanism, by contrast, the wavelength of the pump radiation is chosen such that the pump radiation is absorbed in the quantum layers and generates a population inversion directly there.

Efficient operation requires a sufficiently high absorption of the pump radiation in the quantum well structure.

In this case, the first pump mechanism has the advantage that the barrier layers are generally made considerably thicker than the quantum layers. Thus, the layer thicknesses of barrier layers are typically above 100 nm, while the quantum layers are typically thinner than 10 nm. The proportion P_{abs} of the pump radiation P₀ that is absorbed in a semiconductor layer is to an approximation an exponential function of the layer thickness d and the absorption coefficient α and is given by the relationship

P_{abs}(d)=P₀(1−e^{-αd})

Consequently, as far as possible a complete absorption of the pump radiation is considerably facilitated by the larger layer thickness of the barrier layers, an absorption of typically 80% to 90% of the pump radiation being achievable.

By contrast, the second pump mechanism, that is to say the direct pumping of the quantum layers, is more advantageous with regard to the wavelength of the pump radiation and the energy loss of the pump process in comparison with the first pump mechanism.

Since the barrier layers surround the quantum layers, a higher energy or a shorter wavelength is naturally necessary for generating electron-hole pairs and for generating electron-hole pairs in the quantum layers themselves. Efficient vertical laser operation of the quantum well structure requires a minimum barrier height in order, for example, to avoid a thermal emission of the charge carriers from the quantum wells. For this purpose, typically the energy difference between the conduction bands of barrier layer and quantum layer should be greater than 190 meV and the energy difference between the corresponding valence bands should be greater than 65 meV.

The difference between the energy required for generating the electron-hole pairs and the photon energy corresponding to the emission wavelength is also referred to as quantum defect.

In the case of the first pump mechanism, on account of the minimum barrier height mentioned, the quantum defect typically amounts to 20% to 25%, relative to an emission wavelength of 1,000 nm. Upon the transition of the charge carriers generated in the barrier layers into the lower-energy states of the quantum layers, the quantum defect is converted into phonons and, consequently, is essentially lost as heat loss.

By contrast, the second pump mechanism is distinguished by lower energy losses. Furthermore, in the case of the second pump mechanism, by the barrier layers, it is advantageously possible to form higher energy barriers between the quantum wells since charge carrier separation is not effected in the barrier layers and so a quantum defect which increases with the height of the barrier layers does not occur either.

British Patent GB 2 369 929 furthermore discloses a vertical external cavity semiconductor laser (VECSEL) having a microresonator for the pump radiation, so that the pump radiation passes through the active layer twice. The microresonator is bounded by a Bragg mirror in this case.

However, the combination of a Bragg mirror for the pump resonator and a Bragg mirror for the vertical emitter significantly increases the production outlay. Moreover, scattering losses caused by the multiplicity of the interfaces at the Bragg mirrors can impair the efficiency. In particular, Bragg mirrors have a comparatively poor thermal conductivity, so that, in the case of relatively high pump or output powers, adequate dissipation of the heat loss can pose technical problems which, in the case of the first pump mechanism, are further aggravated by the latter's comparatively high quantum defect.

The second pump mechanism has fundamental advantages, therefore, for realizing high output powers. However, use of the pump mechanism initially necessitates achieving high absorption of the pump radiation in the quantum layers.

One possibility for increasing the pump radiation absorption in the case of the second pump mechanism is to increase the number of quantum layers. However, this only enables a limited increase in efficiency, as has been shown by simulation calculations. In this case, by way of example, a standard VECSEL structure with 15 barrier layers and 14 quantum layers respectively disposed in between was taken as a basis, approximately 90% of the pump radiation being absorbed by the first pump mechanism, that is to say pumping of the barrier layers. In the case of the second pump mechanism, by contrast, only approximately 8% of the pump radiation is absorbed given four quantum layers, approximately 15% given 14 quantum layers, and approximately 50% given 50 quantum layers. It emerges from this that, given otherwise unchanged conditions, the second pump mechanism overall achieves a significantly lower absorption than in the case of the first pump mechanism, it being possible to increase the degree of absorption only to a limited extent by a higher number of quantum layers. Furthermore, the simulation calculations have shown that the laser properties of the vertical emitter deteriorate when the number of quantum layers is increased.

### SUMMARY OF THE INVENTION

It is accordingly an object of the invention to provide an optically pumped semiconductor device which overcomes the above-mentioned disadvantages of the prior art devices of this general type, which has an improved pump efficiency, in particular the quantum layers being pumped efficiently.

With the foregoing and other objects in view there is provided, in accordance with the invention, an optically pumped semiconductor device. The device has a semiconductor body containing a vertically emitting quantum well structure for generating a vertical radiation field. The quantum well structure contains a plurality of quantum layers and barrier layers disposed between the quantum layers. The quantum layers are provided for optically pumping by a pump radiation field. A vertical resonator is provided for receiving the pump radiation field and has a mirror layer disposed on the semiconductor body. The quantum well structure is disposed within the vertical resonator.

In this case, the invention is based on the concept of increasing the absorption of the pump radiation by a resonant coupling of the pump radiation field with the quantum layers.

For this purpose, an optically pumped semiconductor device according to the invention has, in a first embodiment, a semiconductor body containing a vertically emitting quantum well structure for generating a vertical radiation field. The quantum well structure contains a plurality of quantum layers between which barrier layers are disposed, and the quantum layers are provided for optically pumping by a pump radiation field. A vertical resonator is provided for the pump radiation field (pump resonator), in which the quantum well structure is disposed. In this case, the pump resonator is bounded by a mirror layer applied to the semiconductor body.

In the context of the invention, quantum well structure is to be understood as, in particular, any structure with a plurality of layers that are dimensioned such that a quantization of the charge carrier energy levels that is essential for the generation of radiation occurs. A typical quantum well structure has a plurality of quantum layers and barrier layers, the quantum layers being significantly thinner than the barrier layers, and a barrier layer in each case being disposed between two adjacent quantum layers. Such a structure is also referred to as a resonant periodic gain (RPG) structure. In the context of the invention, this is to be understood to mean both structures with a constant distance between adjacent quantum layers and structures in which the distance between adjacent quantum layers varies. Furthermore, it is also possible to provide even further layers, for example intermediate layers between the quantum layers and the barrier layers, thus resulting approximately in a staircase-like energy profile. In this case, barrier layers are to be understood respectively as those layers that define the maximum energy of the quantum well structure, that is to say the energy ranges outside the quantum well.

In the case of the invention, the pump resonator advantageously achieves a resonant increase in the pump radiation absorption. Moreover, the mirror layer of the pump resonator is disposed outside the semiconductor body and can thus be optimized with regard to a sufficient thermal conductivity.

Preferably, the mirror layer of the pump resonator is formed as a metallization that is applied to the semiconductor body and results in a particularly high thermal conductivity which, in particular, significantly exceeds the thermal conductivity of Bragg mirrors.

Moreover, metallizations are distinguished by a high reflectivity with a comparatively low wavelength dependence. In this case, it is advantageous to form the mirror layer in multilayer fashion with a very thin adhesion layer at the semiconductor body and a subsequently disposed thicker reflection layer.

The adhesion layer preferably contains the material platinum, titanium and/or chromium, and the reflection layer applied thereto preferably contains at the materials gold, silver and/or copper. Depending on the pump wavelength, gold is suitable for the infrared and long-wave visible spectral range, silver is essentially suitable for the entire visible spectral range and copper for the short-wave visible and ultraviolet spectral range.

In this case, the adhesion promoter layer is made so thin that it absorbs only a tolerably small proportion of the pump light and the reflection of the metallization is essentially determined by the reflection layer. Preferably, the thickness of the adhesion promoter layer is less than or equal to 1 nm, particularly preferably less than or equal to 0.5 nm. More widely, it is furthermore possible to provide a diffusion barrier between the reflection layer and the semiconductor body, the diffusion barrier expediently being made as similarly thin as the adhesion promoter layer.

In a further advantageous refinement of the invention, the mirror layer of the pump resonator is embodied as a dielectric mirror, for example in the form of a dielectric layer stack applied to the semiconductor body.

The refinements mentioned can also advantageously be combined, the mirror layer preferably at the semiconductor body containing a dielectric mirror and subsequently a metallic reflector layer. This refinement is distinguished by a particularly high reflectivity, in which case a metallic adhesion layer can advantageously be dispensed with.

The pump resonator is preferably formed by the mirror layer applied to the semiconductor body and an opposite interface of the semiconductor body. This may be, by way of example, a coupling-out area for the vertical radiation, an interface formed between the semiconductor body and a protective layer applied thereto, for instance a dielectric or another interface formed within the semiconductor body. Furthermore, the pump resonator may, however, also be bounded for example by a surface of a protective layer applied to the semiconductor body, for instance a dielectric.

In a further variant the semiconductor body may be disposed on a substrate that is transmissive to the pump radiation, for example a growth substrate or a cooling element which is disposed on that side of the semiconductor body which is opposite to the mirror layer of the pump resonator, the pump radiation being coupled in through the substrate. In this case, the interface between substrate and semiconductor body or the substrate surface, together with the mirror layer, may also form the pump resonator.

Furthermore, it is also possible to form the pump resonator with an external mirror or even a pump resonator with a plurality of external mirrors, for example in the form of a folded pump resonator. In this variant, it is advantageously possible to provide for the pump radiation to pass multiply through the vertically emitting quantum well structure. An external mirror for the pump radiation field may also serve for reflecting back radiation components of the pump radiation field that emerge from the pump resonator in the direction of the quantum well structure.

In a preferred refinement of the invention, the semiconductor body has a further mirror layer, which forms a resonator for the vertical emitter. The further mirror layer is preferably formed as a Bragg mirror. The Bragg mirror may be optimized for the wavelength of the vertical radiation field, so that this results in a particularly high reflectivity or a particularly low circulation loss for the resonator of the vertical emitter.

It should be noted that there are different requirements made of the mirror layer for the pump resonator and for the vertical emitter. Thus, in the case of a mirror for the pump radiation, larger losses can be compensated for more easily by increasing the pump radiation power than resonator circulation losses of the vertical emitter. By way of example, a reflectivity of 95% is more than sufficient for the mirror layer of the pump resonator, whereas the reflectivity is generally inadequate for the resonator of the vertical emitter since it leads to excessively high circulation losses. Therefore, a Bragg mirror, for example with a reflectivity of 99.98%, is preferable for the resonator of the vertical emitter, whereas a mirror layer having a lower reflectivity in favor of simultaneously high thermal conduction is preferable for the pump resonator. Moreover, a certain tolerance with respect to changes in wavelength is advantageous in the case of the mirror layer of the pump resonator.

In this connection, conventional contact metallizations which admittedly necessarily have a certain reflectivity, but the latter is far lower than the abovementioned reflectivity and typically amounts to approximately 30% to 40%, are not to be regarded as a mirror layer in the sense of the invention. The further mirror layer for the vertical emitter is preferably disposed on the same side of the quantum well structure as the mirror layer for the pump resonator, so that the vertical radiation field can be coupled out from the semiconductor body on the opposite side to the metallization.

In an advantageous development of the invention, the mirror layer for the vertical emitter is embodied in partly transmissive fashion, the mirror layer in conjunction with the mirror layer for the pump resonator forming a boundary of the resonator of the vertical emitter. This has the advantage that, in the case of a Bragg mirror as the mirror layer for the vertical emitter, fewer layer periods are necessary, which advantageously have the effect that its thickness decreases and its thermal conductivity increases. In particular, a pump resonator with a dielectric mirror is advantageous for this development.

In a second embodiment, an optically pumped semiconductor device according to the invention has a semiconductor body containing a vertically emitting quantum well structure for generating a vertical radiation field. The quantum well structure has a plurality of quantum layers between which barrier layers are disposed. The quantum layers are provided for optical pumping by a pump radiation field. The pump radiation field forms a pump standing wave field with a plurality of stationary first antinodes and the vertical radiation field forms a vertical standing wave field with a plurality of stationary second antinodes, and the quantum layers are disposed in such a way that they overlap both the first and the second antinodes. The quantum layers are thus disposed in resonant fashion spatially both with respect to the pump radiation field and with respect to the vertical radiation field.

This configuration of the quantum layers results in advantageously high coupling both to the pump radiation field and to the vertical radiation field. By contrast, conventional devices generally have a spatially periodic configuration of quantum layers in accordance with the antinodes of the vertical emitter field, so that, although a high efficiency is achieved in the generation of the vertical radiation field, a maximum absorption of the pump radiation is not achieved.

Preferably, in the case of the invention, the quantum layers are disposed in a plurality of groups, the distance between the groups being greater than the distance between two adjacent quantum layers within a group. In this case, the groups are positioned in the regions in which the antinodes of the pump standing wave field overlap the antinodes of the vertical standing wave field.

In this case, the distance between the groups approximately corresponds to the beat wavelength of pump radiation and vertical radiation or an integer multiple thereof. The distance between the quantum layers within a group is preferably less than the distance between the groups and further preferably corresponds approximately to the wavelength of the vertical radiation or an integer multiple thereof.

A particularly preferred development of the invention has the features of the first embodiment, that is to say a vertical resonator for the pump radiation field, and of the second embodiment, that is to say an overlap between the quantum layers and the antinodes both of the pump standing wave field and of the vertical standing wave field, it likewise being possible to combine advantageous developments and refinements of the invention in this regard.

In the context of the invention, provision is made, in particular, of optical pumping of the quantum layers in accordance with the second pump mechanism described above. In this case, the pump radiation field is primarily absorbed in the quantum layers, as a stipulation the absorption in the quantum layers at least being greater than that in the barrier layers. Preferably, the barrier layers and the quantum layers are embodied such that the absorption in the barrier layers is negligible. This is the case in particular when the absorption in the barrier layers is so low that it has no significant influence on the generation of the vertical radiation field.

Preferably, AlGaAs (AlₓGa₁₋ₓAs, 0≦x≦1) is used as semiconductor material for the semiconductor body or the quantum well structure. Furthermore, InₓAl_{y}Ga_{1-y}As, InₓAl_{y}Ga_{1-x-y}N, InₓAl_{y}Ga_{1-x-y}P or InₓGa₁₋ₓAs_{y}N_{1-y}, in each case where 0≦x≦1, 0≦y≦1, 0≦x+y≦1 are also suitable. It goes without saying that the invention is not restricted to one of said semiconductor materials.

The invention is preferably embodied as a semiconductor wafer laser, for example as a VCSEL or VECSEL. In particular, the vertical emitter is provided for forming a vertically emitting laser with an external resonator (VECSEL), the resonator being formed for example by the further mirror layer, for example in the form of a Bragg mirror, and an external mirror.

In a preferred development of the embodiment, an element for frequency conversion, for example for frequency doubling, is provided within the external resonator. By way of example, nonlinear optical elements, in particular nonlinear crystals, are suitable for this purpose.

Other features which are considered as characteristic for the invention are set forth in the appended claims.

Although the invention is illustrated and described herein as embodied in an optically pumped semiconductor device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a graph illustrating an extinction coefficient and a refractive index of an optically pumped semiconductor device as a function of pump wavelength according to the invention;

FIG. 2 is a diagrammatic, section view of a first exemplary embodiment of a semiconductor device according to the invention;

FIG. 3 is a graph illustrating the reflection and absorption of pump radiation as a function of the pump wavelength in the case of the first exemplary embodiment;

FIG. 4 is a diagrammatic, section view of a second exemplary embodiment of the semiconductor device according to the invention;

FIG. 5 is a graph illustrating a vertical standing wave field and a position of the quantum layers in the case of the second exemplary embodiment;

FIG. 6 is a graph illustrating the pump standing wave field and the position of the quantum layers in the case of the second exemplary embodiment;

FIG. 7 is a graph illustrating the reflection and absorption of the pump radiation as a function of the pump wavelength in a first wavelength range for the second exemplary embodiment;

FIG. 8 is a graph illustrating the reflection and absorption of the pump radiation as a function of the pump wavelength in a second wavelength range for the second exemplary embodiment;

FIG. 9 is a graph illustrating the reflection and absorption of the pump radiation as a function of the pump wavelength in the case of an optically pumped semiconductor device according to the prior art; and

FIGS. 10A and 10B are graphs illustrating the vertical and pump standing wave fields and of the position of the quantum layers in the case of an optically pumped semiconductor device according to the prior art.

### DESCRIPTION OF THE PREFERRED EMBODIMENTS

In all the figures of the drawing, sub-features and integral parts that correspond to one another bear the same reference symbol in each case.

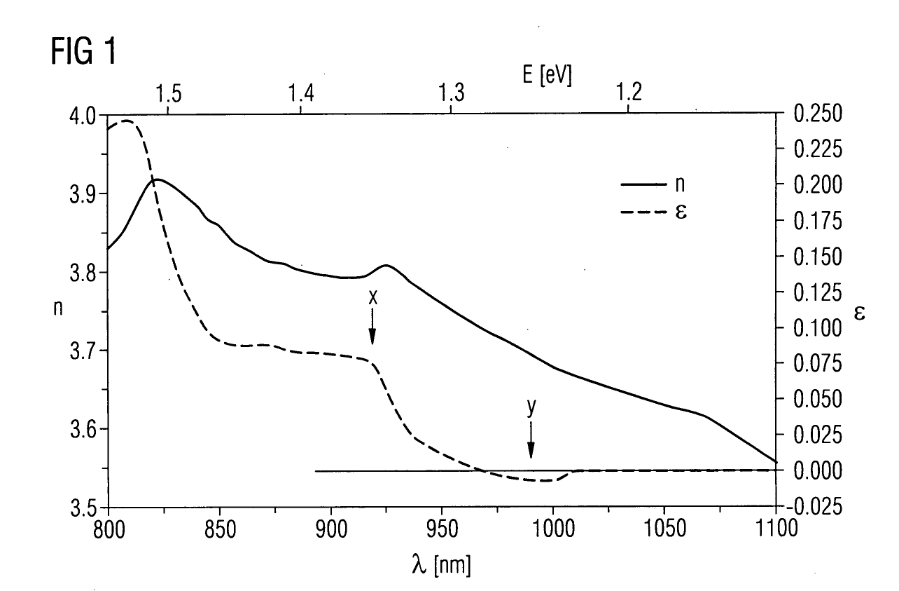

As a basis of a second pump mechanism, that is to say direct pumping of the quantum layers of a quantum well structure, FIG. 1 shows the dependence of the extinction coefficient ε and of the refractive index n on the pump wavelength λ for an exemplary quantum well structure with 14 quantum layers, which is configured for an emission wavelength of 995 nm (arrow Y). This dependence was determined theoretically on the basis of kxp band structure calculations for a thermal Fermi charge carrier distribution, this being based on typical temperatures and charge carrier densities for a semiconductor wafer laser above the laser threshold.

FIG. 1 reveals that a significant absorption of the pump radiation field commences for pump wavelengths of less than or equal to approximately 920 nm (arrow X). For longer pump wavelengths the absorption is significantly lower on account of occupied energy states (Pauli blocking). A pump wavelength of 920 nm corresponds to a quantum defect of approximately 8.7%, which is thus significantly lower than the typical quantum defect of 20% to 25% during the pumping of the barrier layers. Moreover, during the pumping of the quantum layers, the charge carrier trapping times are shorter (typically 10 ps in comparison with 50 ps during the pumping of the barrier layers), thereby advantageously promoting a filling of the upper laser level of the quantum well structure. The extinction and absorption coefficients resulting from FIG. 1 were used as basis for the simulation calculations described below.

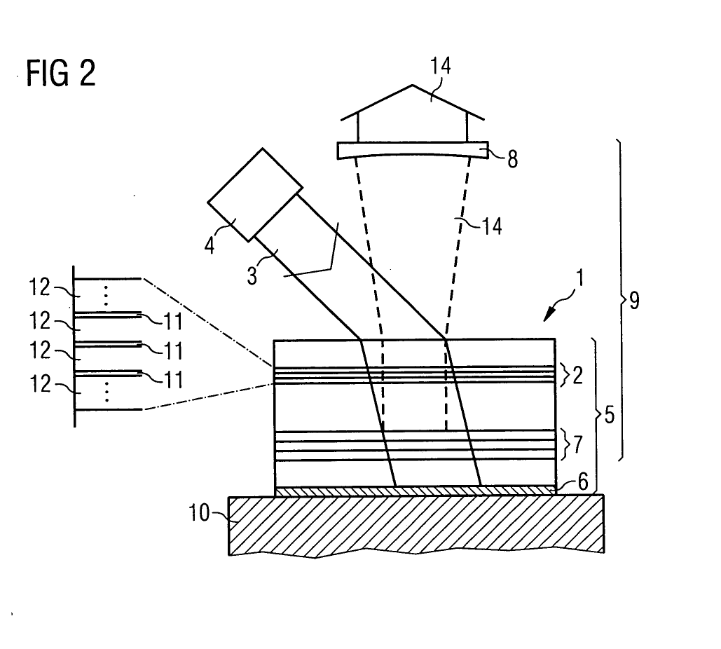

The exemplary embodiment of an optically pumped semiconductor device according to the invention, as shown in FIG. 2, has a semiconductor body 1, preferably in the form of a semiconductor wafer laser, which contains a vertical emitter with a vertically emitting quantum well structure 2. The quantum well structure 2 is formed as an RPG structure with 14 quantum layers 11 between which a barrier layer 12 is in each case disposed. The quantum and barrier layers 11, 12 are grown one on the other in the form of AlGaAs semiconductor layers having different compositions and are configured for an emission wavelength of 1,000 nm. The distance between two adjacent quantum layers corresponds to the emission wavelength.

A pump radiation 3 for optically pumping the vertically emitting quantum well structure 2 is generated by an external pump radiation source 4, for example a diode laser, and radiated onto the semiconductor body 1 obliquely at a predetermined angle of 45°.

The optical pumped semiconductor device furthermore has a resonator 5 which receives the pump radiation 3, and is formed by a mirror layer 6 in the form of a metallization applied to the semiconductor body 1 and the opposite semiconductor surface. A heat sink 10, preferably a metallic heat sink, is preferably disposed on a side of the mirror layer 6 remote from the semiconductor body 1.

The metallization may contain for example a 0.3 nm thick adhesion layer made of platinum applied to the semiconductor body with a reflection layer—disposed thereon—in the form of a gold layer having a thickness of between 100 nm and 1,000 nm. It should be noted that the adhesion layer thickness conventionally lies between 5 nm and 50 nm in the case of such mirror layers. The reflectivity that can be achieved thereby is comparatively low however. In the case of the invention, by contrast, a significant reduction of the adhesion layer thickness results in an advantageously high reflectivity, determined principally by the reflection layer.

A gold layer as the reflection layer is advantageous in particular for a pump wavelength in the infrared spectral range. If appropriate, a silver layer would be preferable for shorter pump or emission wavelengths in the visible range or a copper layer would be preferable for wavelengths in the visible blue and ultraviolet spectral ranges.

Disposed between the metallization 6 and the quantum well structure 2 is a further mirror layer 7 in the form of a Bragg mirror, which, together with an external mirror 8, forms an external resonator 9 for a vertical radiation field 14 generated by the quantum well structure 2. The further mirror layer 7 is disposed on the same side of the quantum well structure 2 as the mirror layer 6. The vertical radiation 14 field is coupled out on the opposite side of the semiconductor body 1 or through the external mirror 8.

In a variant of this exemplary embodiment, the periodicity of the Bragg mirror may be reduced, so that the Bragg mirror is partly transmissive. In this case, the external resonator 9 is formed by the external mirror 8, on the one hand, and the Bragg mirror 7 in conjunction with the mirror layer of the pump resonator.

A semiconductor device according to the invention may be fabricated for example by first growing the semiconductor body 1 in the form of an epitaxial semiconductor layer sequence on a growth substrate and then applying the mirror layer 6 on the side remote from the growth substrate. A carrier, which preferably simultaneously serves as the heat sink 10, is thereupon fixed on the mirror layer 6 and the growth substrate is then removed.

As an alternative, a growth substrate which is sufficiently transparent to the pump radiation field and the vertical radiation field and is preferably undoped may also be used, which growth substrate is not removed from the semiconductor layers, the pump radiation being coupled in through the substrate and the vertical radiation field being coupled out through the substrate. In a further alternative, the growth substrate is thinned or else removed, for example etched away region by region in the radiation coupling-in and coupling-out regions. Finally, the growth substrate may also be removed and a radiation-transmissive heat sink, for example made of diamond or sapphire, may be disposed in its place.

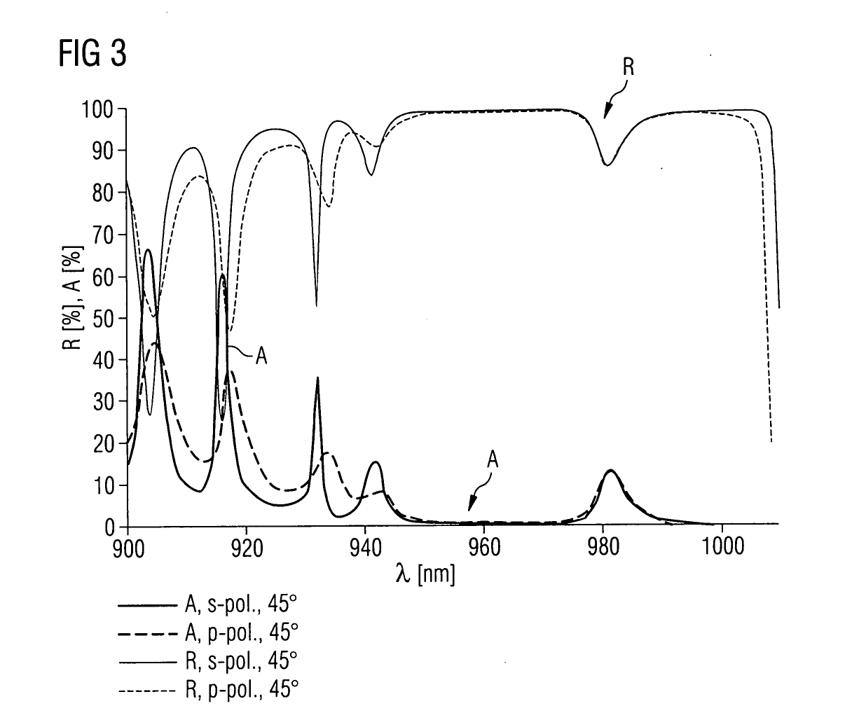

FIG. 3 graphically illustrates the dependence of the pump radiation absorption and reflection on the pump wavelength λ for a structure corresponding to FIG. 2. The dependencies were determined on the basis of simulation calculations.

FIG. 3 plots the absorption A for pump radiation which is polarized perpendicular to the plane of incidence (s-polarization) and for pump radiation which is polarized parallel to the plane of incidence (p-polarization), and also the corresponding reflection coefficient R for s-polarization and p-polarized pump radiation, in each case for an angle of incidence of the pump radiation of 45° with respect to the normal to the semiconductor layer system.

In this case, the absorption corresponds to that proportion of the pump radiation that is absorbed in the quantum layers 11, and the reflection coefficient corresponds to that proportion of the pump radiation that is reflected at the surface of the semiconductor layer system.

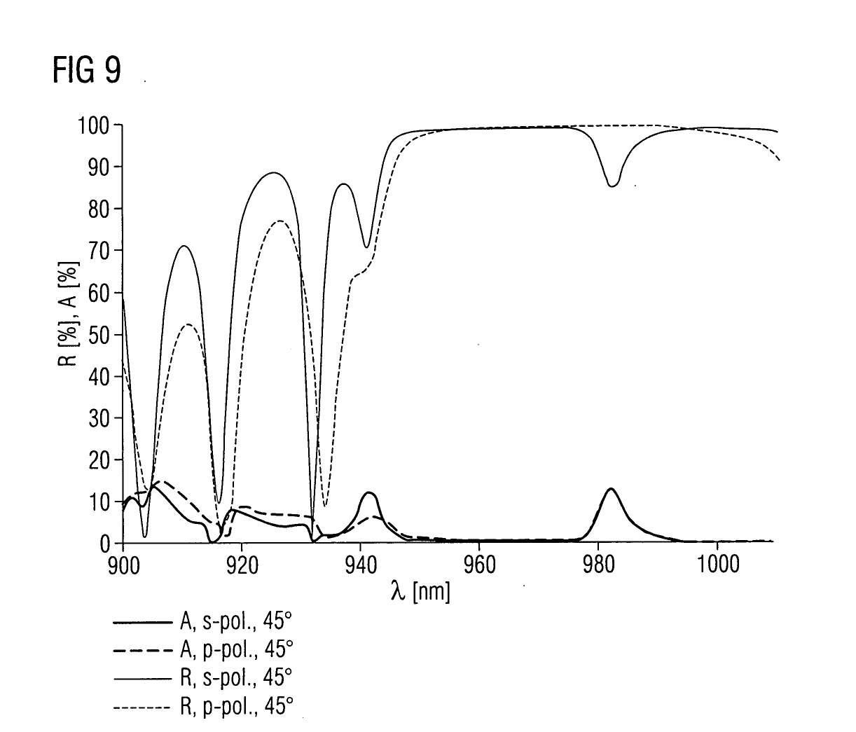

Sharp absorption maxima with corresponding reflection minima are clearly discernable. The maxima correspond to the resonances of the vertical microresonator for the pump radiation 5 for the above-mentioned angle of incidence of 45°, the mirror layer according to the invention resulting in an advantageously large resonant increase with an absorption of 15% to 65%. For comparison, FIG. 9 correspondingly illustrates the absorption and the reflection of an configuration corresponding to FIG. 1 without a mirror layer according to the invention. The absorption maxima are admittedly present on account of the resonator formed by the surfaces of the semiconductor body, but they are significantly less pronounced.

It should be noted that, in the case of an angle of incidence of 45°, the pump radiation, in the semiconductor body, does not propagate parallel to the resonator axis of the pump resonator. In this respect, the resonances in FIGS. 1 and 2 are strictly speaking quasi-resonances whose wavelength is shifted slightly relative to the natural resonances of the pump resonator. It goes without saying that, in the context of the invention, the pump radiation field can also be radiated parallel to the resonator axis.

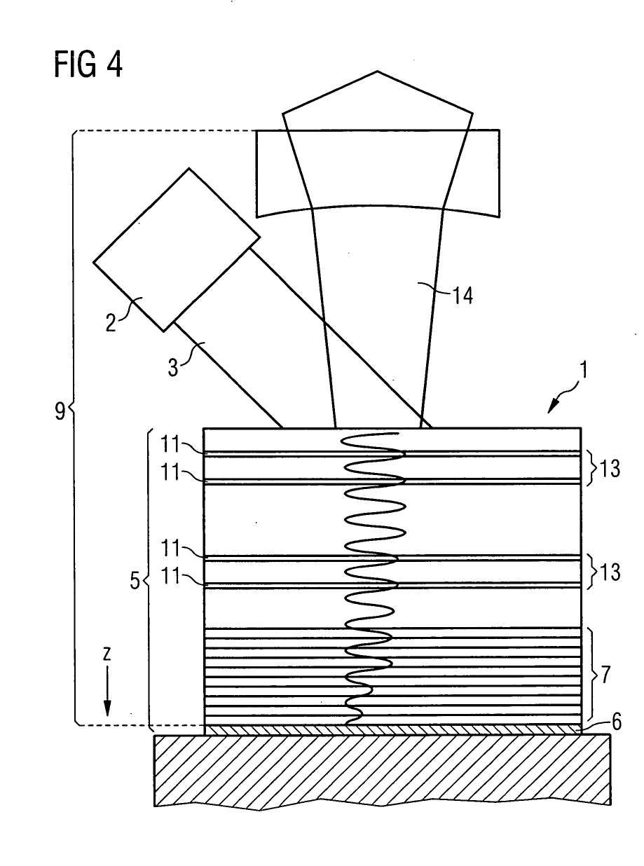

FIG. 4 illustrates a second exemplary embodiment of the invention. In contrast to the exemplary embodiment shown in FIG. 2, the quantum layers 11 are disposed in groups 13, the distance between the groups 13 being greater than the distance between adjacent quantum layers 11 within a group. Two groups each having two quantum layers 11 are illustrated, merely by way of example.

The pump radiation field 3 forms, within the pump resonator 5, a pump standing wave field with a plurality of stationary first antinodes. In a corresponding manner, the vertical radiation field 14 also forms, within the external resonator 9, a vertical standing wave field with a plurality of stationary second antinodes. The different wavelengths of pump and vertical radiation fields give rise to a spatial beat between these wave fields.

The quantum layers 11 or groups 13 are positioned, then, such that the quantum layers 11 overlap both the antinodes of the pump standing wave field and the antinodes of the vertical standing wave field. Thus, the quantum layers 11 are positioned in spatially resonant fashion with respect to the pump radiation field and with respect to the vertical radiation field and in resonant fashion with respect to the beat between these two wave fields.

The quantum layers 11 are preferably disposed in two groups 13 each having 5 quantum layers and one group 13 having 4 quantum layers.

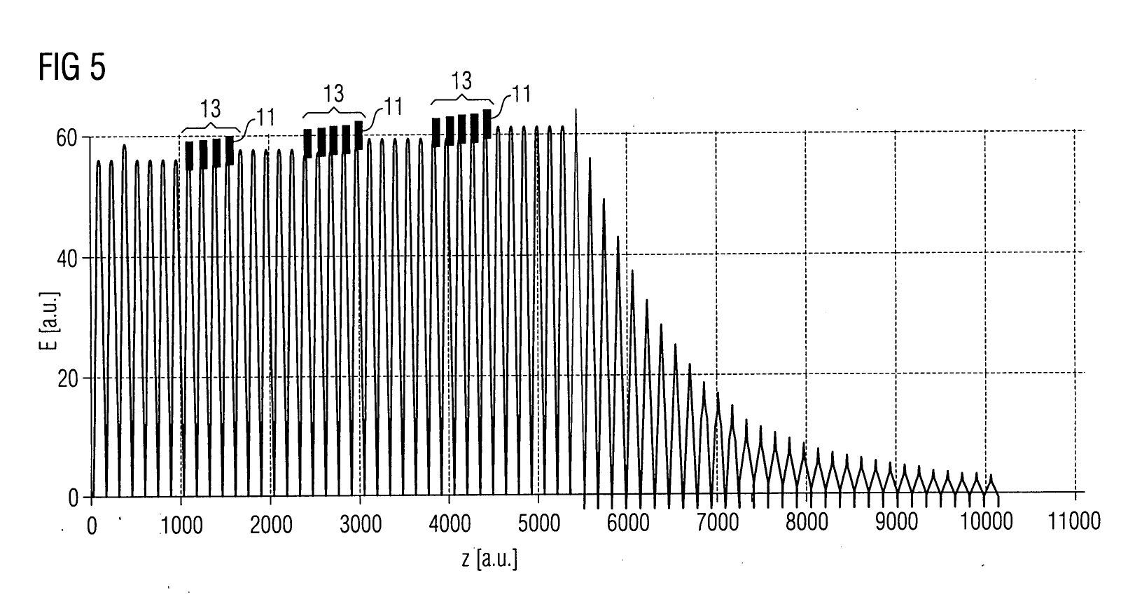

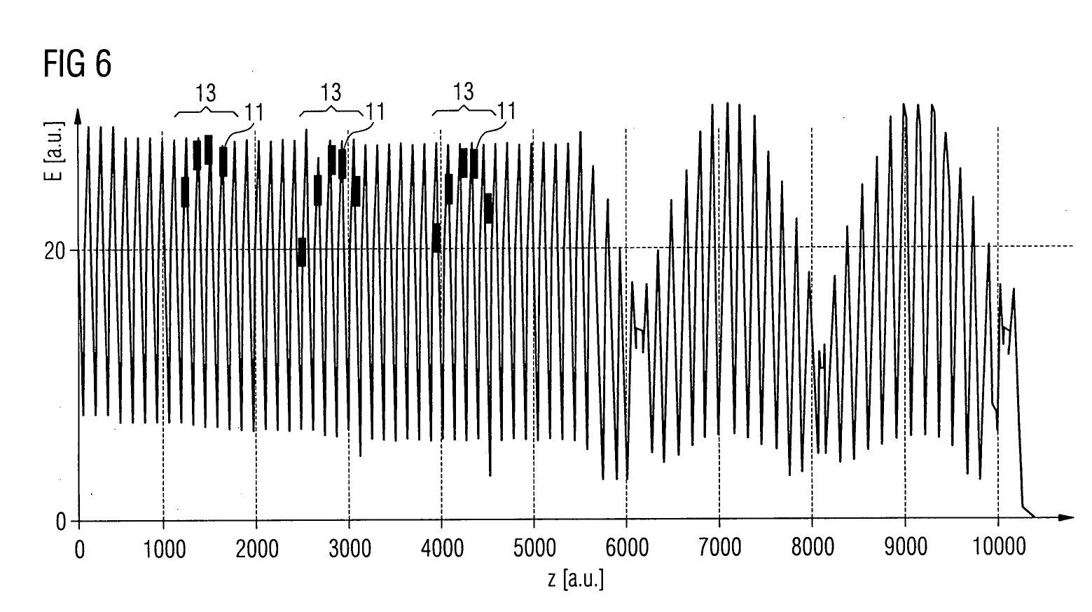

FIG. 5 diagrammatically illustrates the field strength E of the vertical radiation field along the vertical z-axis (see FIG. 4) with a wavelength of 1,000 nm. FIG. 6 shows a corresponding diagrammatic illustration of the field strength E of the pump radiation field with a wavelength of 903 nm and an irradiation angle of 45°. The positions of the quantum layers 11 are marked in both figures, the abscissa of these positions specifying a measure of the overlap with the corresponding radiation field.

The positioning shown once again results in an advantageously high efficiency by virtue of the fact that the quantum layers overlap both the antinodes of the pump standing wave field and the antinodes of the vertical radiation field.

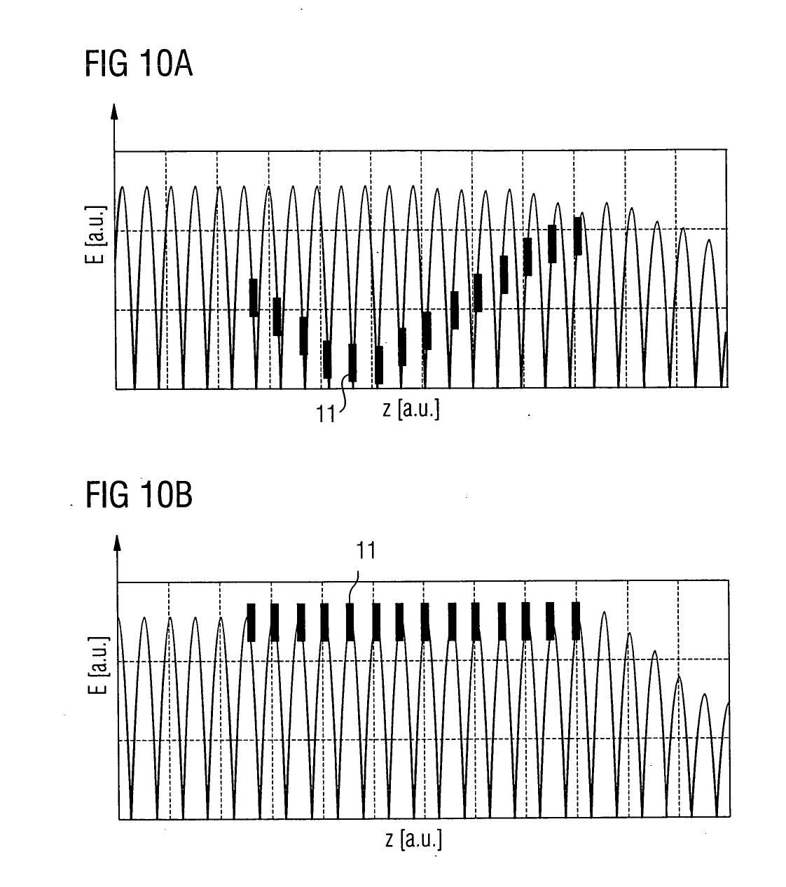

By contrast, FIGS. 10A and 10B show for comparison the positioning of the quantum layers of a corresponding semiconductor device in which the quantum layers are disposed at a constant distance from one another in accordance with the emission wavelength. FIG. 10A shows the vertical field profile of the pump radiation field and FIG. 10B shows the corresponding profile of the vertical radiation field.

This configuration has the effect that although the quantum layers maximally overlap the antinodes of the vertical radiation field, FIG. 10A, the plurality of quantum layers rather overlaps a node than an antinode of the pump radiation field, FIG. 10B.

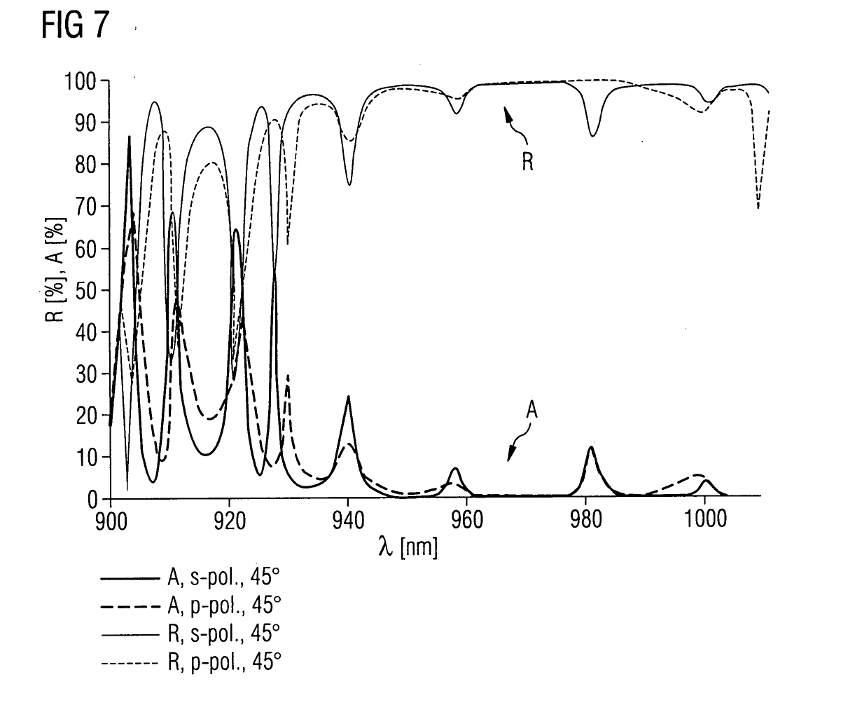

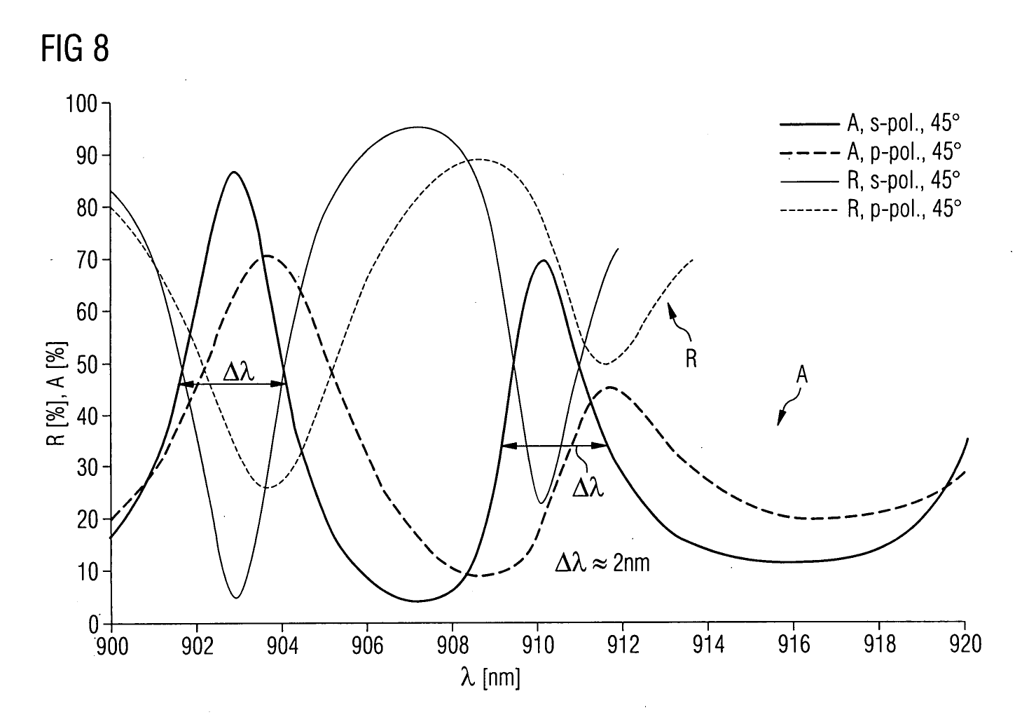

FIGS. 7 and 8 illustrate, in the same way as in FIG. 3, the absorption and reflection of the pump radiation as a function of the wavelength for the second exemplary embodiment shown in FIG. 4. FIG. 7 shows for comparison the same wavelength range as FIG. 3 of 900 nm to 1,000 nm, and FIG. 8, for the sake of clarity, shows an extract therefrom between 900 nm and 920 nm.

As clearly emerges from a comparison with FIG. 3 and FIG. 9, the grouping results in a further advantageous increase in the pump radiation absorption up to 80% at a pump wavelength of 903 nm. The spectral width of the resonance at 903 nm is approximately 2 nm. Furthermore, the pump wavelength corresponds to an advantageously small quantum defect of approximately 10%.

It should be noted that, in the context of the invention, it is also possible to provide a corresponding grouping of the quantum layers without the vertical resonator for the pump radiation with a metallization as mirror layer, since even this grouping alone suffices for an advantageous increase in the pump radiation absorption compared with the prior art.

The explanation of the invention on the basis of the exemplary embodiments described is not to be understood as a restriction of the invention thereto. Rather, the invention also encompasses the combinations with all other features mentioned in the exemplary embodiments and the rest of the description even if said combinations are not the subject of a patent claim.

This application claims the priority, under 35 U.S.C. § 119, of German patent application No. 103 23 821.2, filed May 23, 2003; the entire disclosure of the prior application is herewith incorporated by reference.

1. An optically pumped semiconductor device, comprising:
a semiconductor body containing a vertically emitting quantum well structure for generating a vertical radiation field, said quantum well structure containing a plurality of quantum layers and barrier layers disposed between said quantum layers, said quantum layers provided for optically pumping by a pump radiation field; and
a vertical resonator for the pump radiation field, said vertical resonator having a mirror layer disposed on said semiconductor body, and said quantum well structure disposed within said vertical resonator.

2. The semiconductor device according to claim 1, wherein said mirror layer contains a metallization.

3. The semiconductor device according to claim 1, wherein said mirror layer contains a dielectric mirror.

4. The semiconductor device according to claim 3, wherein said dielectric mirror is applied to said semiconductor body and said mirror layer further contains a metallization disposed on a side of said dielectric mirror which is remote from said semiconductor body.

5. The semiconductor device according to claim 1, wherein said mirror layer in conjunction with an interface of said semiconductor body opposite to said mirror layer forms said vertical resonator.

6. The semiconductor device according to claim 1, further comprising an external pump mirror, said mirror layer in conjunction with said external pump mirror forms said vertical resonator.

7. The semiconductor device according to claim 1, further comprising a further mirror layer for forming a further resonator for the vertical radiation field.

8. The semiconductor device according to claim 7, wherein said mirror layer and said further mirror layer are disposed on a same side of said vertically emitting quantum well structure.

9. The semiconductor device according to claim 1, wherein the pump radiation field forms a pump standing wave field with a plurality of first antinodes, and the vertical radiation field forms a vertical standing wave field with a plurality of second antinodes, said quantum layers being disposed such that they overlap both the first and the second antinodes.

10. The semiconductor device according to claim 1, wherein said quantum layers are disposed in a plurality of groups, a distance between said groups being greater than a distance between two adjacent said quantum layers within a group.

11. The semiconductor device according to claim 7, wherein said further mirror layer is a Bragg mirror.

12. The semiconductor device according to claim 1, further comprising an external pump mirror by which radiation components emerging from said vertical resonator are reflected back in a direction of said quantum well structure.

13. The semiconductor device according to claim 1, wherein the pump radiation field is absorbed to a greater extent in said quantum layers than in said barrier layers.

14. The semiconductor device according to claim 13, wherein absorption of the pump radiation field in said barrier layers is negligible compared with absorption in said quantum layers.

15. The semiconductor device according to claim 1, further comprising an external resonator, said external resonator and said quantum well structure forming a vertically emitting laser.

16. The semiconductor device according to claim 15, wherein said external resonator has an external mirror.

17. The semiconductor device according to claim 15, wherein said external resonator has an element for frequency conversion such as frequency doubling.

18. The semiconductor device according to claim 1, wherein the semiconductor device is embodied as a semiconductor disk laser.

19. The semiconductor device according to claim 1, wherein said semiconductor body contains at least one semiconductor material selected from the group consisting of InₓAl_{y}Ga_{1-x-y}As, InₓAl_{y}Ga_{1-x-y}N, InₓAl_{y}Ga_{1-x-y}P, in each case where 0x≦1, 0≦y≦1, 0≦x+y≦1, and InₓGa₁₋ₓAs_{y}N_{1-y}, where 0≦x≦1, 0≦y≦1.

20. The semiconductor device according to claim 1, wherein said semiconductor body contains an epitaxial semiconductor layer sequence.

21. The semiconductor device according to claim 1, wherein said semiconductor body is a semiconductor layer sequence removed from a growth substrate.

22. The semiconductor device according to claim 1, further comprising a heat sink disposed on that side of said mirror layer which is opposite to said semiconductor body.

23. The semiconductor device according to claim 1, wherein the pump radiation field is radiated onto a surface of said semiconductor body at a predetermined angle with respect to a normal to said surface, said predetermined angle lying between 0° and 80°.

24. The semiconductor device according to claim i, wherein said quantum well structure contains at least one semiconductor material selected from the group consisting of InₓAl_{y}Ga_{1-x-y}As, InₓAl_{y}Ga_{1-x-y}N, InₓAl_{y}Ga_{1-x-y}P, in each case where 0≦x≦1, 0≦y≦1, 0≦x+y≦1, and InₓGa₁₋ₓAs_{y}N_{1-y}, where 0≦x≦1, 0≦y≦1.

25. An optically pumped semiconductor device, comprising:
a semiconductor body containing a vertically emitting quantum well structure for generating a vertical radiation field, said quantum well structure having a plurality of quantum layers and barrier layers disposed between said quantum layers, said quantum layers provided for optically pumping by a pump radiation field, the pump radiation field forms a pump standing wave field with a plurality of stationary first antinodes, and the vertical radiation field forms a vertical standing wave field with a plurality of second antinodes, said quantum layers disposed such that they overlap both the first and the second antinodes.

26. The semiconductor device according to claim 25, wherein said quantum layers are disposed in a plurality of groups, a distance between said groups being greater than a distance between two adjacent said quantum layers within a group.

27. The semiconductor device according to claim 25, further comprising a vertical resonator for the pump radiation field, said vertical resonator having a mirror layer disposed on said semiconductor body, said quantum well structure disposed within said vertical resonator.

28. The semiconductor device according to claim 25, wherein the pump radiation field is absorbed to a greater extent in said quantum layers than in said barrier layers.

29. The semiconductor device according to claim 28, wherein absorption of the pump radiation field in said barrier layers is negligible compared with absorption in said quantum layers.

30. The semiconductor device according to claim 25, further comprising an external resonator, said external resonator and said quantum well structure forming a vertically emitting laser.

31. The semiconductor device according to claim 30, wherein said external resonator has an external mirror.

32. The semiconductor device according to claim 30, wherein said external resonator has an element for frequency conversion such as frequency doubling.

33. The semiconductor device according to claim 25, wherein said semiconductor device is embodied as a semiconductor disk laser.

34. The semiconductor device according to claim 25, wherein said semiconductor body contains at least one semiconductor material selected from the group consisting of InₓAl_{y}Ga_{1-x-y}As, InₓAl_{y}Ga_{1-x-y}N, InₓAl_{y}Ga_{1-y}P, in each case where 0≦x≦1, 0≦y≦1, 0≦x+y≦1, and InₓGa₁₋ₓAs_{y}N_{1-y}, where 0≦x≦1, 0≦y≦1.

35. The semiconductor device according to claim 25, wherein said semiconductor body contains an epitaxial semiconductor layer sequence.

36. The semiconductor device according to claim 25, wherein said semiconductor body is a semiconductor layer sequence removed from a growth substrate.

37. The semiconductor device according to claim 25, further comprising a heat sink disposed on that side of said mirror layer which is opposite to said semiconductor body.

38. The semiconductor device according to claim 25, wherein the pump radiation field is radiated onto a surface of said semiconductor body at a predetermined angle with respect to a normal to said surface, said predetermined angle lying between 0° and 800.

39. The semiconductor device according to claim 25, wherein said quantum well structure contains at least one semiconductor material selected from the group consisting of InₓAl_{y}Ga_{1-y}As, InₓAl_{y}Ga_{1-x-y}N, InₓAl_{y}Ga_{1-x-y}P, in each case where 0≦x≦1, 0≦y≦1, 0≦x+y≦1, and InₓGa₁₋ₓAs_{y}N_{1-y}, where 0≦x≦1, 0≦y≦1.

40. The semiconductor device according to claim 37, wherein said heat sink is a metallic heat sink.
